(19) United States
(12) Patent Application Publication
(10) Pub. No.: US 2012/0308710 A1
(43) Pub. Date: Dec. 6, 2012

(54) Drink

(75) Inventors: Katja Beck, Illertissen/Au (DE); Peter Horlacher, Bellenberg (DE); Michael Müller, Dietenheim (DE); Sandra Reitlinger, Illertissen/Au (DE); Bettina Schwaier, Munchen (DE)

(73) Assignee: Cognis IP Management GmbH, Dusseldorf (DE)

(21) Appl. No.: 13/577,356

(22) PCT Filed: Jan. 28, 2011
(86) PCT No.: PCT/EP2011/000401

§ 371 Date: Aug. 6, 2012

(30) Foreign Application Priority Data
Feb. 6, 2010 (EP) EP10001238

(51) Int. Cl. A23L 2/52; A23D 9/007; A23D 7/00; A23L 2/38

(52) U.S. Cl. 426/573; 426/590; 426/602; 426/599

(57) ABSTRACT

The present invention relates to a drink which is an oil-in-water emulsion and which comprises hydrocolloids, where the hydrocolloids are a mixture of gellan and pectin, and where the oil phase or fat phase comprises sterols or stanols or fatty acid esters of sterols or fatty acid esters of stanols or a mixture of these substances. The hydrocolloids prevent or retard the settling of a precipitate of the oil phase or fat phase of the oil-in-water emulsion.

The present invention relates to a drink which is an oil-in-water emulsion and which comprises hydrocolloids, where the hydrocolloids are a mixture of gellan and pectin, and where the oil phase or fat phase comprises sterols or stanols or fatty acid esters of sterols or fatty acid esters of stanols or a mixture of these substances. The hydrocolloids prevent or retard the settling of a precipitate of the oil phase or fat phase of the oil-in-water emulsion.

It is known that hydrocolloids such as pectin, gellan, carboxymethylcellulose (CMC) etc. are used for stabilizing drinks, i.e. are used for preventing or retarding the settling of particles in drinks. The particles here are e.g. particles of fruit pulp or fruit flesh which would settle in the drink without stabilization. This stabilization is achieved primarily by increasing the viscosity of the drinks by means of the viscosity-increasing hydrocolloids used here.

The creaming of particles in drinks is prevented by adding auxiliaries such as emulsifiers or so-called “weighting agents”. This is likewise known from the prior art. The so-called “weighting agents” lead to an alignment of the density of the particles suspended in the drinks and of the continuous, liquid phase surrounding them. The “weighting agents” here increase e.g. the density of oil particles or fat particles which are dispersed in aqueous phase so that the oil particles or fat particles no longer cream.

There is the need, in drinks which are oil-in-water emulsions, where the oil phase or fat phase has a higher density than the aqueous phase, and where the oil phase or fat phase comprises sterols or stanols or fatty acid esters of sterols or fatty acid esters of stanols or a mixture of these substances, to retard or to prevent the settling of a precipitate.

U.S. Pat. No. 6,627,245 discloses stable, homogeneous, emulsifier-free suspensions of hydrophobic substances which comprise a thickener, where, inter alia, pectin and gellan are specified as thickeners. Here, the thickener is preferably used in a concentration such that the viscosity of the suspension is at least 50 mPas. Below this viscosity, the suspensions are not stable. High-viscosity suspensions of this type are unsuitable for many drink applications because they do not meet the expectation of the consumer with regard to the viscosity of a drink.

There is thus still the need to retard or to prevent the settling of a precipitate in the specified drinks without, in exchange, the viscosity of the drinks having to be increased considerably, for example to 50 mPas or greater.

WO 2005/102074 discloses in example A a drink which is a protein suspension which is stabilized by pectin.

U.S. Pat. No. 5,641,532 discloses in example 1 a drink which is an oil-in-water emulsion which is stabilized with gellan.

US 2007/0178213 discloses aerated milk products which comprise, inter alia, gellan.

WO 2008/128765 discloses a CLA-containing yoghurt drink which comprises pectin.

WO 2007/066234 discloses a drink which is an emulsion which is stabilized with pectin.

Nahrung, Volume 40, pages 60-67 (1996) discloses whey protein emulsions which comprise modified pectins.

U.S. Pat. No. 7,147,885 discloses in claim 8 a dispersion stabilizer comprising isolated acetylated gellan and pectin.

It is an object of the present invention to provide a drink which is an oil-in-water emulsion in which an oil phase or fat phase is dispersed in a water phase, and in which the oil phase or fat phase has a higher density than the water phase, and where the oil phase or fat phase comprises sterols or stanols or fatty acid esters of sterols or fatty acid esters of stanols or a mixture of these substances, the aim being to prevent or at least retard or reduce to an extent the settling of a precipitate of oil particles or fat particles in a drink without emulsifiers or weighting agents having to be used mandatorily for this purpose. In this connection, the sensory quality of the drink, the so-called mouth feel, should not be adversely affected, or at least not considerably adversely affected, by the measure which is taken in order to prevent or at least retard or reduce to an extent the settling of oil particles or fat particles in the drink. Moreover, it should be possible to adjust the viscosity of the drink to the lowest possible value, e.g. to less than 50 mPas, and nevertheless to achieve the desired reduction in settling.

This object is achieved by the drink which is defined in the claims of the present specification. This drink is one subject matter of the present invention.

Here, it is an essential element of the present invention that a mixture of gellan and pectin is used as hydrocolloid. The use of gellan on its own or the use of pectin on its own in many cases does not allow a stable emulsion to be obtained, unless gellan or pectin is used in such a large amount that the viscosity of the emulsion becomes undesirably high (see in this respect U.S. Pat. No. 6,627,245). The use of the mixture of gellan and pectin according to the invention makes it possible to obtain stable emulsions without the viscosity of the emulsion having to be undesirably high.

A further subject matter of the present invention is a fat powder which, as intermediate, can serve for producing the drink according to the invention. The fat powder according to the invention is defined in the claims of the present specification.

A further subject matter of the present invention is an emulsion which, as intermediate, can serve for producing the drink according to the invention. The emulsion according to the invention is defined in the claims of the present specification.

A further subject matter of the present invention is a method for producing the drink according to the invention from the fat powder according to the invention.

A further subject matter of the present invention is a method for producing the drink according to the invention from the emulsion according to the invention.

A further subject matter of the present invention is the use of a hydrocolloid for slowing or for preventing the settling of the oil phase or fat phase in a drink which is an oil-in-water emulsion, where the drink and the oil phase or fat phase are preferably a drink and an oil phase or fat phase as defined as being in accordance with the invention in the present specification.

Surprisingly, it has been found that fat powders which comprise hydrocolloids and are dispersed in an aqueous phase such that aqueous phase and fat powder together produce a drink, where the drink and the fat powder are those as defined in the claims of the present specification, settle only in a very retarded manner, if at all, in this drink. In this connection, it is possible, by selecting suitable hydrocolloids, namely a mixture of gellan and pectin, to ensure that the viscosity of the drink is not significantly increased. This can be advantageous because an excessively high viscosity can reduce the acceptance of a drink by the consumer in certain cases.

Instead of the fat powders, it is also possible for an oil to be emulsified in an aqueous phase, in which case, the emulsion obtained in this way comprises a hydrocolloid, the drink and the oil being as defined in the claims of the present specification. In this connection as well, a drink is obtained in which the oil settles only in a very retarded manner, if at all. In this case too, it is possible, by selecting suitable hydrocolloids, namely a mixture of gellan and pectin, to ensure that the viscosity of the drink is not significantly increased. This can be advantageous because an excessively high viscosity can reduce the acceptance of a drink by the consumer in certain cases.

The drinks according to the invention are oil-in-water emulsions. Here, a nonpolar oil phase or fat phase is emulsified or suspended in a polar water phase.

Suitable as oil phase or fat phase are any desired oils and/or fats suitable for drinks provided they comprise sterols or stanols or fatty acid esters of sterols or fatty acid esters of stanols or a mixture of these substances. Preferably, the oils or fats have a density of more than 1 kg/l, preferably of more than 1.02 kg/l, in particular of more than 1.05 kg/l. Fats are understood as meaning substances which are solid at 20° C.; oils are understood as meaning substances which are liquid at 20° C.

Suitable fatty acids in the fatty acid esters of sterols or fatty acid esters of stanols are any desired fatty acids, in particular those having 6 to 20, in particular those having 10 to 18, carbon atoms.

As well as the actual oils or fats, the oils or fats can furthermore comprise in particular: carotenoids, fat-soluble vitamins such as vitamin A, D, E, K or derivatives thereof and phospholipids.

In one embodiment of the invention, those hydrocolloids are used which do not increase, or do not significantly increase, the viscosity of the drink according to the invention. An insignificant increase is present if the viscosity of the drink at 20° C. and a hydrocolloid content of 1% by weight in the drink is increased not by more than 30%, preferably not by more than 20%, in particular not by more than 10%, compared with the drink without hydrocolloid.

In one particular embodiment, the drink according to the invention comprises, based on 100 parts by weight of aqueous phase, 0.01 to 10 parts by weight of oil phase or fat phase, in particular 0.025-5 parts by weight of oil phase or fat phase and 0.001 to 5 parts by weight of hydrocolloid, in particular 0.05 to 1 part by weight of hydrocolloid.

The present invention has numerous advantages. The drink has a neutral taste and it does not have an oily, greasy mouth feel. To prevent or retard settling of a precipitate, for fat powders or emulsions, no further emulsifiers are required if the hydrocolloids according to the invention are used. To stabilize the drink, no additional technological measures, such as e.g. homogenization, are required.

In the present specification, all % data hereinbelow are % by weight, unless defined otherwise.

In one embodiment, the fat powder according to the invention has a fat content of 20-80%. In one embodiment, the fat powder according to the invention has a hydrocolloid content of 5-40%. In one embodiment, the fat powder according to the invention has a content of carrier substances of 15-75%. In one embodiment, the fat powder according to the invention has a water content of at most 8%.

The fat powders according to the invention can be produced by spray-drying or by other drying methods or by mixing.

In one embodiment, the emulsion according to the invention for producing the drink according to the invention has a fat content of 20-60%. In one embodiment, the emulsion according to the invention for producing the drink according to the invention has a hydrocolloid content of 2-10%. In one embodiment, the emulsion according to the invention for producing the drink according to the invention has an emulsifier content of 0.5-5%. In one embodiment, the emulsion according to the invention for producing the drink according to the invention has a water content of 38-78%.

According to the invention, suitable carrier substances are in particular: milk protein, soya protein, gum arabic, modified starch, e.g. succinate starch (E 1450). Carrier substances can serve to emulsify the fat in the water phase before the spray-drying and later in the powder state to envelope the fat.

According to the invention, emulsifiers can also be used. According to the invention, suitable emulsifiers are: monoglycerides of fatty acids and esters thereof, lecithins, sugar esters, polysorbates, polyglycerol esters. The specified carrier substances can also sometimes have an emulsifying effect, meaning that sometimes the addition of emulsifiers can be dispensed with.

Emulsion drinks can be produced from the following ingredients: drink base, a fat powder according to the invention or an emulsion according to the invention, water, other additives.

According to the invention, drink base is understood as meaning a semi-finished product which generally comprises apart from water, sugar and acid all ingredients which are necessary for producing a standardized drink, such as e.g. fruit juice or fruit juice concentrate, sweetening component (e.g. sugar or sweetener), aromas, coloring fruit extracts or plant extracts, antioxidants, vitamins etc.

According to the invention, of suitability as other additives are: antioxidants, dyes, fruit extracts, plant extracts, aroma substances.

### EXAMPLES

In the present specification, all % data are percentage by weight, unless defined otherwise.

The trade marks used below refer to the products defined below and are available via the stated sources of supply.
Vegapure® FTE comprises phytosterols; source of supply: Cognis GmbH, Monheim,

Germany
Vegapure® F 40 WDPE comprises phytosterols; source of supply: Cognis GmbH, Monheim, Germany
Kelcogel® PS is a mixture of sucrose, gellan (E 418) and pectin; source of supply: CP Kelco Germany GmbH, Groβenbrode, Germany
The gum arabic used was the commercial product Quick-Gum Type 8074; available from ALFRED L. WOLFF GmbH, Hamburg, Germany
The pectin (E 440) used was the commercial product Genu Pectin VIS, available from CP Kelco Germany GmbH, Groβenbrode, Germany. This is a pectin standardized with sucrose; here, standardized means that the pectin is adjusted to a certain viscosity value with sucrose so that there is no change in the end product despite fluctuating raw material qualities (harvest-dependent).
Kelcogel® F is a gellan (E 418); source of supply: CP Kelco Germany GmbH, Groβenbrode, Germany

### Example 1

Formulation of a Fat Powder with Hydrocolloids

32% Vegapure® FTE (oil phase or fat phase)

48% Gum arabic (hydrocolloid)

20% Kelcogel® PS

Preparation of a Fat Powder with Hydrocolloids Having the Formulation Above

The gum arabic and the Kelcogel® PS were stirred into water at 20° C. 65 parts by weight of water were used based on 35 parts by weight of the formulation above. The resulting dispersion was heated to 65-70° C. Vegapure® FTE was then dispersed into this first dispersion (water phase) with vigorous stirring. The dispersion obtained in this way was homogenized in two stages (with the pressure settings 220/30 bar in the homogenizer). The spray-drying was carried out with an atomizing disk at 24 000 revolutions per minute and at an incoming air temperature of 185° C.

The production of the fat powder can be produced by spray-drying or by other drying methods or by mixing.

### Example 2

### Formulation of an Emulsion Drink

1.04% fat powder with hydrocolloids according to example 1

92.46% water

6.5% drink base (orange-carrot-lemon from Rudolf Wild GmbH & Co. KG, Eppelheim/Heidelberg, Type 35000080660000)

Preparation of an Emulsion Drink with Hydrocolloids Having the Formulation Above

The three components were mixed and pasteurized (at least 85° C. for 30 seconds). The emulsion drinks obtained in this way were then bottled.

### Example 3

Formulations of Emulsion Drinks Tested in this Example

| Formulation | SR 1702 | SR 1703 | SR 1704 | SR 1705 | SR 1707 | SR 1708 | SR 1709 |
|---|---|---|---|---|---|---|---|
| Water | 99.13% | 98.88% | 98.83% | 99.11% | 97.63% | 97.33% | 97.13% |
| Vegapure F | 0.87% | 0.87% | 0.87% | 0.87% | 0.87% | 0.87% | 0.87% |
| 40 WDP E | | | | | | | |
| Kelcogel PS | | 0.25% | 0.3% | | | | |
| Kelcogel F | | | | 0.02% | | | |
| Genu Pectin | | | | | 1.5% | 1.8% | 2.0% |
| VIS | | | | | | | |

SR 1702 is a comparison formulation without hydrocolloid.

Preparation of Emulsion Drinks with the Formulations with Hydrocolloids Having the Above Formulation SR 1702, SR 1703, SR 1704, SR 1705, SR 1707, SR 1708 and SR 1709

The dry substances were stirred into water with stirring. This mixture was gently stirred continuously for 10 min. Then, the mixture was heated to 85° C. for 30 sec, poured into bottles while hot and then cooled to room temperature. The bottles containing emulsion drink were stored in the standing position and in the lying position. When it came to sedimentation, this was evidently more rapid for the samples in the lying position.

### Assessment of the Drinks According to Example 3

In the case of formulations SR 1703, SR 1704 and SR 1709, no settling of the fat powder was evident even after storage for 8 weeks. In the case of comparative example SR 1702, considerable sedimentation was visible after just 2 hours. In the case of formulations SR 1705, SR 1707 and 1708, sedimentation was visible after 1 day.

Sensory Assessment after Storage for 4 Days

| | Formulation | | | | | | |
|---|---|---|---|---|---|---|---|
| Taste | SR 1702 | SR 1703 | SR 1704 | SR 1705 | SR 1707 | SR 1709 | SR 1709 |
| Musty | 0 | 0 | 0.67 | 0.67 | 1.17 | 1.50 | 1.50 |
| Sandy | 0.17 | 0.33 | 0.50 | 0.33 | 0.00 | 0.00 | 0.00 |
| Chalky | 0.50 | 0.17 | 0.50 | 0.33 | 0.17 | 0.17 | 0.17 |
| Bitter | 0.17 | 0.33 | 0.33 | 0.83 | 0.33 | 0.33 | 0.33 |
| Strange | 0 | 0.83 | 1.33 | 2.17 | 2.00 | 2.50 | 2.50 |
| Mouth feel | 0.17 | 1.00 | 1.67 | 1.33 | 2.50 | 2.83 | 2.83 |
| Accepted | 3 | 3 | 3 | 0 | 0 | 0 | 0 |
| Not accepted | 0 | 0 | 0 | 3 | 3 | 3 | 3 |

Assessment:
0 = no taste, not evident
1 = slight difference, slight taste
2 = considerable difference, strong taste
3 = very considerable difference, very strong taste
In sensory terms, the formulations SR 1703 and SR 1704 according to the invention were preferred.

1-15. (canceled)

16. A drink which is an oil-in-water emulsion comprising an aqueous phase, an oil phase or fat phase which is dispersed in the aqueous phase, and at least one hydrocolloid, wherein the oil phase or fat phase has a higher density than the aqueous phase, and wherein the hydrocolloid is a mixture of gellan and pectin, and wherein the oil phase or fat phase comprises sterols or stanols or fatty acid esters of sterols or fatty acid esters of stanols or a mixture of these substances.

17. The drink of claim 16, where the drink comprises, based on 100 parts by weight of aqueous phase, 0.01 to 10 parts by weight of oil phase or fat phase and 0.001 to 5 parts by weight of hydrocolloid.

18. The drink of claim 17, wherein the viscosity of the drink at 23° C. is not higher than 50 mPas, as measured using a rotary viscometer of the Bohlin C-VOR type at 23° C. and the parameters 1200 rpm, PP40 (“plate plate 40 mm”) and 0.3 mm gap.

19. The drink of claim 16, wherein the hydrocolloid is a mixture of gellan and pectin in the mass ratio 1:10 to 10:1.

20. The drink of claim 16, wherein the oil phase or fat phase comprises at least 75% by weight of sterols or stanols or fatty acid esters of sterols or fatty acid esters of stanols or a mixture of these substances.

21. The drink of claim 16, wherein the sterols or stanols or fatty acid esters of sterols or fatty acid esters of stanols are phytosterols or phytostanols or fatty acid esters of phytosterols or fatty acid esters of phytostanols.

22. The drink of claim 16, wherein the oil phase or fat phase comprises phytosterols or fatty acid esters of phytosterols.

23. The drink of claim 16, wherein the drink further comprises a component selected from the group consisting of aroma substances, sweeteners, sugars, dyes, antioxidants, plant extracts, fruit extracts, and mixtures thereof.

24. The drink of claim 16, wherein the drink comprises less than 0.1% by weight of proteins.

25. The drink of claim 24, wherein the drink comprises no proteins.

26. The drink of claim 16, wherein the drink comprises less than 0.1% by weight of emulsifiers.

27. The drink of claim 26, wherein the drink comprises no emulsifiers.

28. A fat powder for producing the drink of claim 16, where the fat powder comprises the oil phase or fat phase and the hydrocolloid.

29. An emulsion for producing the drink of claim 16, where the emulsion comprises the oil phase or fat phase, the hydrocolloid, and a portion of the aqueous phase of the drink.

30. A method for producing the drink from the fat powder of claim 28, comprising dispersing the fat powder in the aqueous phase of the drink.

31. A method for producing the drink from the emulsion of claim 29, comprising bringing together the emulsion with the as yet lacking aqueous phase.
